(19) United States
(12) Patent Application Publication
(10) Pub. No.: US 2016/0023129 A1
(43) Pub. Date: Jan. 28, 2016

(54) One-way drier filter

(71) Applicant: NANTONG OEM REFRIGERATION EQUIPMENT CO., LTD., Nantong, Jiangsu (CN)

(72) Inventor: Xiaohong Ding, Nantong,Jiangsu (CN)

(21) Appl. No.: 14/343,860

(22) PCT Filed: Jan. 8, 2014
(86) PCT No.: PCT/CN2014/070340

§ 371 Date: Apr. 17, 2015

(30) Foreign Application Priority Data
Jan. 8, 2013 (CN) 201320008246.4

(51) Int. Cl. B01D 15/20; F25B 43/00

(52) U.S. Cl. CPC B01D 15/20; F25B 43/003; B01D 15/203

(57) ABSTRACT

A one way drier filter includes: an input end cap with an input opening provided thereon; an output end cap with an output opening provided thereon; a cylinder shell having an inner space, wherein an input end and an output end of the cylinder shell are respectively covered by the input end cap and the output end cap; a granular molecular sieve provided in the inner space of the cylinder shell for dehydrating refrigerating fluid; parallel punched nets; filtering nets; glass fibers; a spring mounted at the input end of the cylinder shell; a hot air pump connected to an air inlet of the output end cap through an air tube; an air inlet valve mounted on the air inlet of the output end cap; and an air outlet valve mounted on an air outlet of the input end cap.

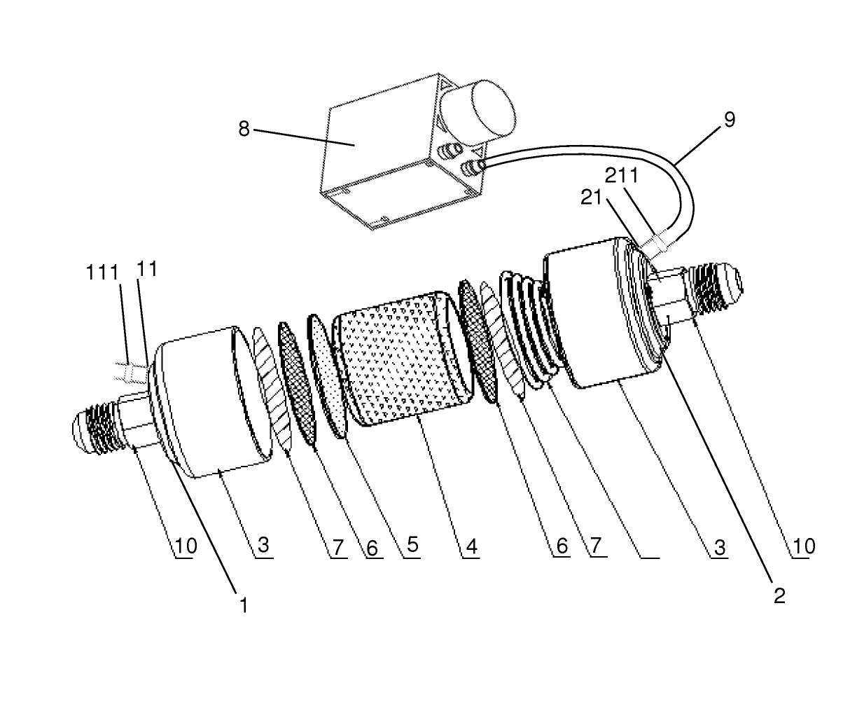

### CROSS REFERENCE OF RELATED APPLICATION

This is a Continuation-In-Parts application of the International Application PCT/CN2014/070340, filed on Jan. 8, 2014, which claims the benefit of CN 201320008246.4 and priority date of Jan. 8, 2013.

### BACKGROUND OF THE PRESENT INVENTION

1. Field of Invention

The present invention relates to a product of a refrigeration equipment field, and more particularly to a one-way drier filter of refrigeration equipment.

2. Description of Related Arts

In refrigeration equipment, a drier filter is essential. The drier filter is utilized for filtering impurities and removing water from refrigerating fluid. The drier filter can be mounted on a corresponding part at a front end of a capillary of a cooling system, on a pipeline, or on an input and output terminal of an electric expansion valve. The drier filter collects solid impurities, removes water from refrigerating fluid, prevents the system, the capillary and the expansion valve from being blocked, and ensures clearness of the pipeline system. Requirements for the direr filter are good absorbability, stacking density, static water adsorption, etc. If the drier filter is abnormal, problems such as ice plug will be caused. As a result, a warm shell will be cooled down, or even be covered by frost and condensate, which will shorten water supply to the evaporator, lower work efficiency of the refrigeration equipment, and interfere the normal work of the refrigeration equipment.

### SUMMARY OF THE PRESENT INVENTION

An object of the present invention is to provide a one-way drier filter for overcoming the above shortcomings, wherein dehydrating and filtering effects thereof are sufficient, a lifetime thereof is long.

Accordingly, in order to accomplish the above object, the present invention provides a one-way drier filter, comprising:

an input end cap with an input opening provided thereon;

an output end cap with an output opening provided thereon;

a cylinder shell having an inner space, wherein an input end and an output end of the cylinder shell are respectively covered by the input end cap and the output end cap;

a granular molecular sieve provided in the inner space of the cylinder shell for dehydrating refrigerating fluid;

parallel punched nets;

filtering nets;

glass fibers;

wherein the parallel punched nets, the filtering nets and the glass fibers are provided in the inner space of the cylinder shell for filtering the refrigerating fluid;

a spring mounted at the input end of the cylinder shell for compressing the granular molecular sieve, the parallel punched net, the filtering nets and the glass fibers;

a hot air pump connected to an air inlet of the output end cap through an air tube, wherein the hot air pump heats air and drives heated air into the cylinder shell for regenerating the granular molecular sieve;

an air inlet valve mounted on the air inlet of the output end cap, wherein when dehydrating and filtering the refrigerating fluid, the air inlet valve is closed for preventing the refrigerating fluid from flowing into the air tube; when regenerating the granular molecular sieve, the air inlet valve is opened; and

an air outlet valve mounted on an air outlet of the input end cap, wherein when dehydrating and filtering the refrigerating fluid, the air outlet valve is closed for preventing the refrigerating fluid from flowing out from the air outlet valve; when regenerating the granular molecular sieve, the air outlet valve is opened;

wherein when regenerating the granular molecular sieve, the heated air is outputted by the hot air pump and is inputted into the cylinder shell; the heated air reversely passes through the granular molecular sieve for regenerating, in such a manner that water is separated from the granular molecular sieve and is carried out from the air outlet valve by the heated air.

Therefore, the present invention has following advantages:

a) sufficient dehydrating and filtering effect;

b) high working pressure; and

c) long lifetime.

These and other objectives, features, and advantages of the present invention will become apparent from the following detailed description, the accompanying drawings, and the appended claims.

### BRIEF DESCRIPTION OF THE DRAWINGS

FIGURE is a perspective view of a one-way drier filter according to a preferred embodiment of the present invention.

### DETAILED DESCRIPTION OF THE PREFERRED EMBODIMENT

Referring to the drawing, a one-way drier filter according to a preferred embodiment of the present invention is illustrated, comprising:

an input end cap 1 with an input opening provided thereon;

an output end cap 2 with an output opening provided thereon;

a cylinder shell 3 having an inner space, wherein an input end and an output end of the cylinder shell are respectively covered by the input end cap 1 and the output end cap 2;

a granular molecular sieve 4 provided in the inner space of the cylinder shell for dehydrating refrigerating fluid;

parallel punched nets 5;

filtering nets 6;

glass fibers 7;

wherein the parallel punched nets 5, the filtering nets 6 and the glass fibers 7 are provided in the inner space of the cylinder shell 3 for filtering the refrigerating fluid;

a spring 8 mounted at the input end of the cylinder shell 3 for compressing the granular molecular sieve 4, the parallel punched net 5, the filtering nets 6 and the glass fibers 7;

a hot air pump 8 connected to an air inlet 21 of the output end cap 2 through an air tube 9, wherein the hot air pump 8 heats air and drives heated air into the cylinder shell 3 for regenerating the granular molecular sieve 4;

an air inlet valve 211 mounted on the air inlet 21 of the output end cap 2, wherein when dehydrating and filtering the refrigerating fluid, the air inlet valve 211 is closed for preventing the refrigerating fluid from flowing into the air tube 9; when regenerating the granular molecular sieve 4, the air inlet valve 211 is opened; and

an air outlet valve 111 mounted on an air outlet 11 of the input end cap 1, wherein when dehydrating and filtering the refrigerating fluid, the air outlet valve 111 is closed for preventing the refrigerating fluid from flowing out from the air outlet valve 111; when regenerating the granular molecular sieve 4, the air outlet valve 111 is opened;

wherein when regenerating the granular molecular sieve 4, the heated air is outputted by the hot air pump 8 and is inputted into the cylinder shell 3; the heated air reversely passes through the granular molecular sieve 4 for regenerating, in such a manner that water is separated from the granular molecular sieve 4 and is carried out from the air outlet valve 111 by the heated air.

Preferably, screwed connectors 10 are respectively mounted on the input end cap 1 and the output end cap 2 for simplifying installation of the one-way drier filter.

Preferably, the parallel punched nets 5, the filtering nets 6 and the glass fibers 7 are symmetrically provided at two sides of the granular molecular sieve 4.

Preferably, a temperature of the heated air from the hot air pump 8 is 200° C.

Preferably, a cooling pipe is connected to the air outlet valve for cooling the heated air and leading the water to a predetermined container.

Preferably, the cylinder shell 3 is an anti-shock steel shell.

Preferably, the cylinder shell 3 is coated with an epoxide powder layer.

Preferably, a max working pressure is 4.7 Mpa.

With the foregoing structure, dehydrating and filtering effects of the one-way drier filter are sufficient, and a lifetime thereof is long.

The one-way drier filter according to the present invention and a conventional drier filter were respectively tested in a same cooling system, wherein the granular molecular sieves of both drier filters were of a same model with same parameters. The experiment was provided twice with two models of molecular sieves. The one-way drier filter is regenerated automatically. The conventional drier filter is regenerated manually. Experimental results are listed in a following table.

Experimental results

| | Model of molecular sieve | | | |
|---|---|---|---|---|
| | Model A | | Model B | |
| | | Conven- | | Conven- |
| | One-way | tional dri- | One-way | tional dri- |
| | drier filter | er filter | drier filter | er filter |
| Life time of molecular | 24 | 18 | 20 | 16 |
| sieve (kh) | | | | |
| Dehydration efficiency | 35.0 | 35.0 | 30.0 | 30.0 |
| after 0/4 life time (%) | | | | |
| Dehydration efficiency | 32.2 | 31.7 | 27.1 | 26.9 |
| after 1/4 life time (%) | | | | |
| Dehydration efficiency | 27.1 | 24.6 | 23.3 | 21.7 |
| after 2/4 life time (%) | | | | |
| Dehydration efficiency | 20.0 | 17.8 | 18.5 | 17.9 |
| after 3/4 life time (%) | | | | |

According to the table, the one-way drier filter is able to increase the life time of the molecular sieves by about 30%. Furthermore, the dehydration efficiency of the one-way drier filter is higher than the conventional drier filter with the same molecular sieve. After 1/2 life time of the molecular sieve, the dehydration efficiency of the one-way drier filter is about 80% of the original efficiency, while the dehydration efficiency of the conventional drier filter is only about 70% of the original efficiency.

Therefore, the one-way drier filter according to the present invention is able to increase the life time of the molecular sieve in such a manner that the life time of the one-way drier filter is increased. At the meantime, the dehydration efficiency of the one-way drier filter is higher than the conventional drier filter with the same molecular sieve. Furthermore, the one-way drier filter is regenerated automatically.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-3. (canceled)

4. A one-way drier filter, comprising:
an input end cap with an input opening provided thereon;
an output end cap with an output opening provided thereon;
a cylinder shell having an inner space, wherein an input end and an output end of said cylinder shell are respectively covered by said input end cap and said output end cap;
a granular molecular sieve provided in said inner space of said cylinder shell for dehydrating refrigerating fluid;
parallel punched nets;
filtering nets;
glass fibers;
wherein said parallel punched nets, said filtering nets and said glass fibers are provided in said inner space of said cylinder shell for filtering the refrigerating fluid;
a spring mounted at said input end of said cylinder shell for compressing said granular molecular sieve, said parallel punched net, said filtering nets and said glass fibers;
a hot air pump connected to an air inlet of said output end cap through an air tube, wherein said hot air pump heats air and drives heated air into said cylinder shell for regenerating said granular molecular sieve;
an air inlet valve mounted on said air inlet of said output end cap, wherein when dehydrating and filtering the refrigerating fluid, said air inlet valve is closed for preventing the refrigerating fluid from flowing into said air tube; when regenerating said granular molecular sieve, said air inlet valve is opened; and
an air outlet valve mounted on an air outlet of said input end cap, wherein when dehydrating and filtering the refrigerating fluid, said air outlet valve is closed for preventing the refrigerating fluid from flowing out from said air outlet valve; when regenerating said granular molecular sieve, said air outlet valve is opened;
wherein when regenerating said granular molecular sieve, said heated air is outputted by said hot air pump and is inputted into said cylinder shell; said heated air reversely passes through said granular molecular sieve for regenerating, in such a manner that water is separated from said granular molecular sieve and is carried out from said air outlet valve by said heated air.

5. The one-way drier filter, as recited in claim 4, wherein screwed connectors are respectively mounted on said input end cap and said output end cap for simplifying installation of said one-way drier filter.

6. The one-way drier filter, as recited in claim 4, wherein said parallel punched nets, said filtering nets and said glass fibers are symmetrically provided at two sides of said granular molecular sieve.

7. The one-way drier filter, as recited in claim 4, wherein a temperature of said heated air from said hot air pump is 180-220° C.

8. The one-way drier filter, as recited in claim 4, wherein a cooling pipe is connected to said air outlet valve for cooling said heated air and leading said water to a predetermined container.

9. The one-way drier filter, as recited in claim 4, wherein said cylinder shell is an anti-shock steel shell.

10. The one-way drier filter, as recited in claim 4, wherein said cylinder shell is coated with an epoxide powder layer.

11. The one-way drier filter, as recited in claim 4, wherein a max working pressure is 4.0-5.0 Mpa.
